(19) United States
(12) Patent Application Publication
(10) Pub. No.: US 2006/0092439 A1
(43) Pub. Date: May 4, 2006

(54) Printer controller, image forming apparatus, image forming program

(75) Inventor: Kazunori Hirabayashi, Tagata-gun (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/978,526

(22) Filed: Nov. 2, 2004

(51) Int. Cl. G06K 9/40; G06F 15/00

(52) U.S. Cl. 358/1.9; 358/518; 382/254

(57) ABSTRACT

A printer controller comprises an interpreting unit which receives a plurality of color image information from outside and interprets the information, a binary converting unit which converts the plurality of color image information into binary information in a pattern depending on the magnitude of the information, and further outputs each of the plurality of color image information in information of the same pattern when the interpreting unit interprets that the color image information is achromatic and that ROP (raster operation) process is needed, an ROP processing unit which applies ROP process to the binary information from the binary converting unit, and a generating unit which generates and outputs information of a pattern for forming an image by black pixel when the plurality of color image information are in information of the same pattern on the basis of the plurality of binary information outputted from the ROP processing unit.

### BACKGROUND OF THE INVENTION

An output of an electrophotographic color printer is generally depicted in four plates, cyan (C), magenta (M), yellow (Y), and black (K). An electrophotographic printer receives PDL (page destination language; PostScript3 (registered trademark), PCL6, etc.) generated by a printer driver, interprets a depicting command, and rasterizes. An apparatus executing this process is called RIP (raster image processor). The RIP converts a color value (RGB 8 bits, etc.) of an object written in the PDL into CMYK (8 bits), and further converts into binary or multibit value by halftone process to develop into a memory, and then transfers the data to an engine. A method of developing image data into a memory includes a method of developing all pixels in CMY 8-bit data, a method of developing in CMYK 8 bits, CMYK 1 bit, CMYK 4 bits, etc. To minimize the memory consumption, it is effective to have CMYK 1-bit data.

When mutually overlaying objects in the RIP, ROP (raster operation) is known. ROP3 performs predetermined logic operations on Destination (original object), Source (object to be depicted), and Texture (object having a pattern of each CMY plane on the object to be depicted), and writes the results of operation in Destination. For processing of ROP3, there are 256 types of combination. For example, there are direct output of Source, and combined output of Destination and Source, etc. Usually, ROP must be done on RGB or CMY multibit values, and if ROP process is attempted on the basis of CMYK binary data, it cannot be expressed correctly. Accordingly, the data is supplied into the print controller without information of component K. To avoid this problem, a method of producing component K from the binary state is known. This method is to depict as component K when bits are set up at all positions in each plane from the binary information of CMY.

However, it is general to depict the output of the electrophotographic color printer in four plates, cyan (C), magenta (M), yellow (Y), and black (K). In the case of achromatic depiction by the electrophotographic color printer, three manners are considered, that is, depiction by CMYK composite black, depiction by only component K, and depiction by CMY composite black. In an achromatic image object such as natural picture, it is general to express black by CMY or CMYK. This is because the gradation becomes rich by using CMYK colors. However, achromatic characters and graphics (line art) are preferred to be depicted by only K. Further, from the viewpoint of saving of toner consumption or the like, an image object expressed in achromatic color is also preferred to be reproduced by only component K.

It is because plate deviation may occur due to the structure of the electrophotographic color printer, and when the object is depicted by CMY or CMYK, colors are blurred and it does not seem to be achromatic (having a tint of red or blue) or sharp, and further a relatively expensive color toner is used in depiction of black.

Herein, by halftone processing in depiction of the object, in the case of processing configuration in which a binary or multibit (screened) achromatic object is subjected to ROP, the information of component K before this configuration is lost, and it is impossible to reproduce black by only component K. Although it is desired to depict by only component K in the achromatic object, it is depicted by the composite black of components CMY. It leads to the above problems.

As countermeasure, it has been proposed to extract and produce component K on the basis of the information after ROP. That is, before input of ROP, information of component K is copied (OR) in CMY plane, and from each binary CMY plane after ROP, positions on which all bits are set up in the CMY plane are extracted as components K, and components K are produced. By this method, information showing black can be extracted completely, but halftone information of the achromatic color cannot be extracted. Since the halftone of the achromatic color (for example, C=M−Y=128 in 256 gradations) has been already processed into a binary or multibit value (screened) before ROP input, bits of CMY are hardly overlaid, and it is hard to extract the information of black (FIG. 8A).

Further, when using and overlaying mask patterns, from the viewpoint of saving of a memory etc., or viewpoint of ROP4 (using mask bit map and specifying the place in which ROP3 is used), K plane may be used for holding the mask pattern defined by the user, and the original K plane information may be lost. It is hence difficult to output by the image signal of component K only from the printer controller.

### BRIEF SUMMARY OF THE INVENTION

One embodiment of the present invention is a printer controller comprising: an interpreting unit which receives a plurality of color image information from outside and interprets the information; a binary converting unit which converts the plurality of color image information into binary information in a pattern depending on the magnitude of the information, and further outputs each of the plurality of color image information in information of the same pattern when the interpreting unit interprets that the color image information is achromatic and that ROP (raster operation) process is needed; an ROP processing unit which applies ROP process to the binary information from the binary converting unit; and a generating unit which generates and outputs information of a pattern for forming an image by black pixel when the plurality of color image information are the same pattern information on the basis of the plurality of binary information outputted from the ROP processing unit.

### BRIEF DESCRIPTION OF THE SEVERAL VIEWS OF THE DRAWING

FIG. 1 is a system diagram showing an example of a configuration of a printer controller and an image forming apparatus according to an embodiment of the invention;

FIG. 2 is a flowchart of processing according to a first embodiment in the printer controller and image forming apparatus of the invention;

FIG. 3 is a flowchart of processing according to a second embodiment in the printer controller and image forming apparatus of the invention;

FIG. 4 is a flowchart of processing according to a third embodiment in the printer controller and image forming apparatus of the invention;

FIG. 5 is a flowchart of processing according to a fourth embodiment in the printer controller and image forming apparatus of the invention;

FIG. 6 is a flowchart of processing according to a fifth embodiment in the printer controller and image forming apparatus of the invention;

FIG. 7 is an explanatory diagram of outline of ROP in the printer controller and image forming apparatus of the invention;

FIG. 8A is a pattern diagram showing an achromatic color without processing of the invention in the printer controller and image forming apparatus of the invention;

FIG. 8B is a diagram of expression of an achromatic color in the invention;

FIG. 8C is a diagram of an output of an achromatic color in a prior art; and

FIG. 8D is a diagram of an output of an achromatic color in the invention.

### DETAILED DESCRIPTION OF THE INVENTION

Referring now to the drawings, a printer controller according to an embodiment of the present invention, an image forming apparatus using the same, and an example of an image forming program will be descried in detail below.

### First Embodiment

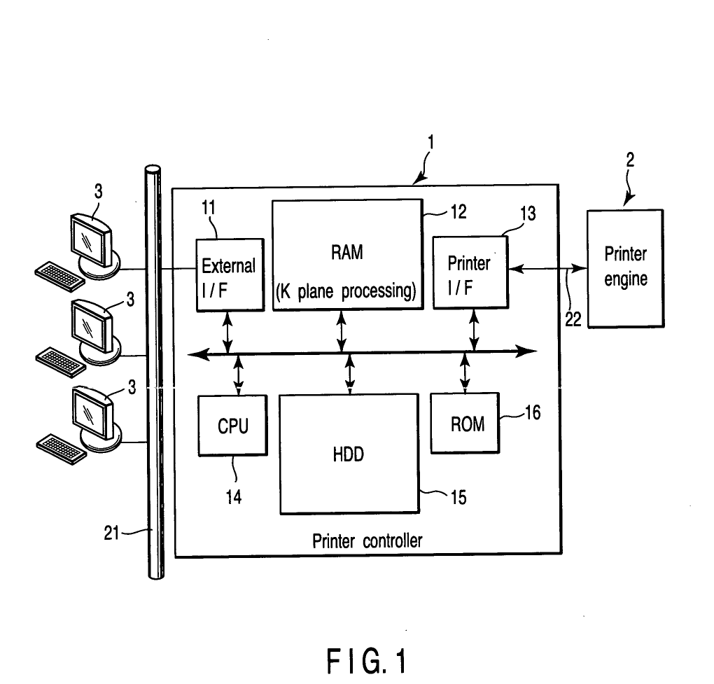

A first embodiment of the present invention is intended to output a print control signal expressing an achromatic signal (achromatic image data) by a K signal only without using YMC signals by K plane processing in a printer controller, and form an image of only K toner in a printer engine. FIG. 1 is a system diagram showing an example of a configuration of a printer controller and an image forming apparatus according to an embodiment of the invention. The image forming system of the invention comprises, in FIG. 1, a printer controller unit 1 connected to a personal computer 3 or the like through a network 21 or the like, and a printer engine 2 connected to the printer controller unit 1. In the invention, K plane processing is, for example, executed as a program on the printer controller in FIG. 1. The printer controller unit 1 incorporates a CPU 14, a RAM 12, a ROM 16, an HDD 15, an external I/F 11, and a printer I/F 13, and they can communicate with each other by way of a communication path 21. The printer controller unit 1 can communicate with the printer engine 2 by way of the communication path 21 through the external I/F 13.

In the embodiment of the invention, first, in the personal computer 3 or the like, PDL (PostScript Level 3 (a registered trademark of adobe), PCL6) is produced depending on an image signal for forming an image by using the printer driver. The PDL is transmitted to MFP (multi function product) by way of network or other transfer medium, and once accumulated as a file in the MFP. A RIP (raster image processor) first opens a PDL file (image processing command), reads and interprets the PDL data by an interpreter, and generates a low level depiction list. The depiction list is sent to a printing engine. This K plane processing in the embodiment of the invention is executed when generating such a low level depiction list.

The embodiment of the invention is directed to output an image signal (image or image data) indicating an achromatic object accompanied by ROP as an image signal of only component K, not as composite black of CMY or CMYK. That is, after conversion from RGB color space to CMYK or CMY color space, halftone is processed to convert into binary or multibit value, and the ROP is processed, and the data after ROP is operated by K plane processing.

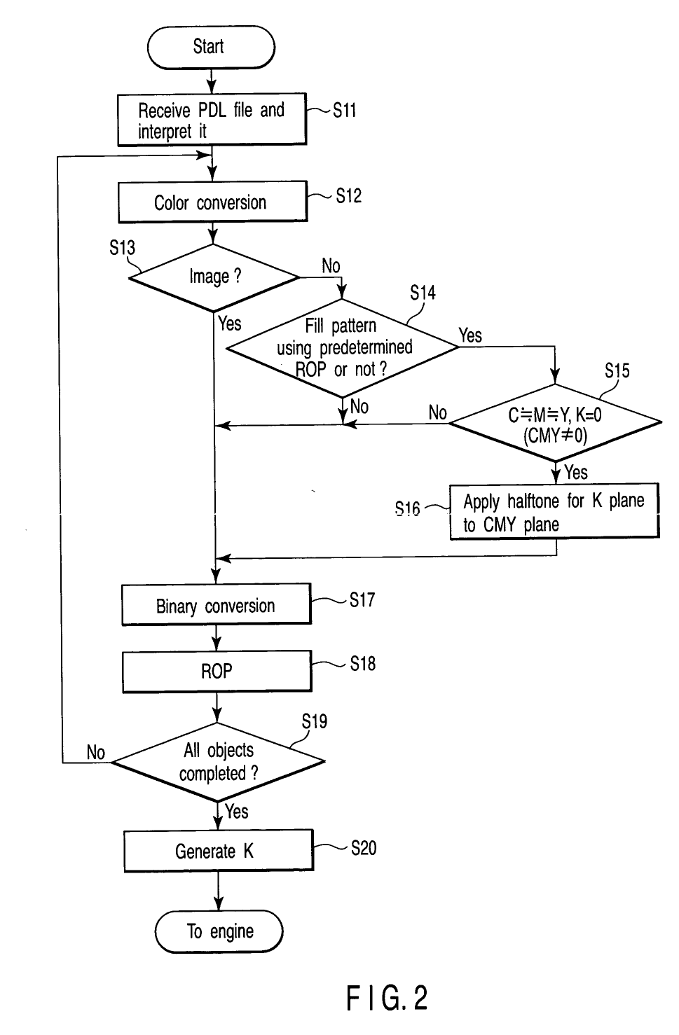

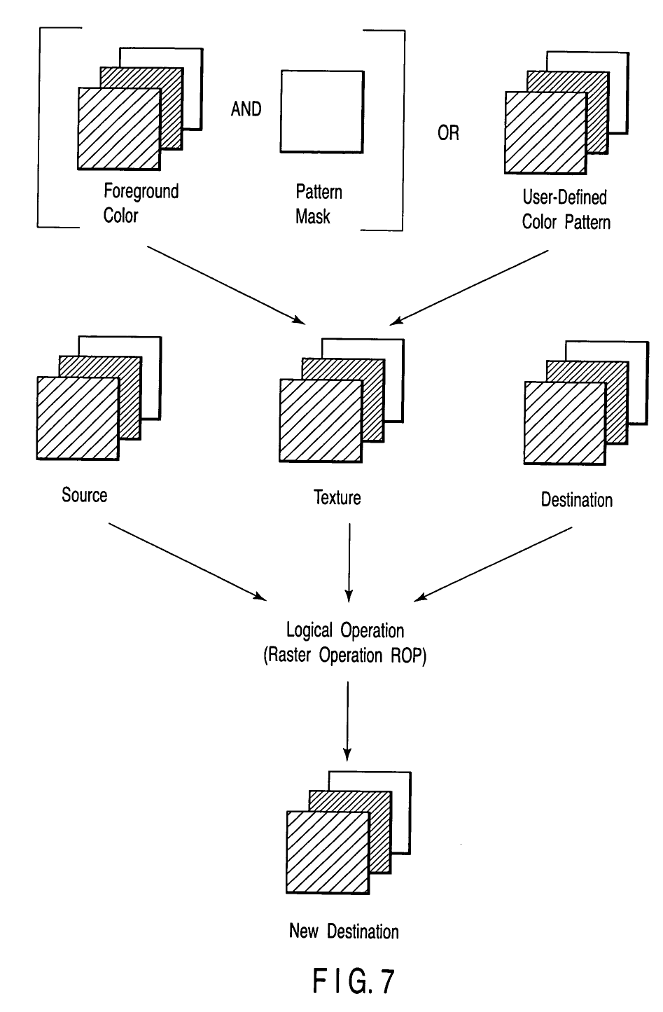

The K plane processing according to the invention will be explained below by referring to the flowchart in FIG. 2. A conceptual diagram of ROP is shown in FIG. 7 (cited from the conceptual diagram of ROP in PCL). The ROP processes as shown in FIG. 7, on Destination (original object), Source (object to be depicted), and Texture (object having a pattern of each CMY plane on the object to be depicted).

In the invention, K plane processing is to receive an image signal, for example, a PDL file from the personal computer 3 or the like and interpret it, in the flowchart in FIG. 2 (S11). Then, the object color is converted (S12). The color of the input object is, for example, a color value (8 bits, luminance data) of RGB color space. The color value of input object is converted into a color value of color space of a device by color conversion logic. In an electrophotographic printer 2, it is general to depict in four colors of CMYK, and hence the color value is converted into CMYK (for example, 8 bits) in this embodiment.

If the target object is not an image object, but is graphics or a text object expressed as raster data (S13), it is then determined whether or not to be a predetermined ROP type (texture defined as Destination) (S14).

When the image signal is to be processed by predetermined ROP (S14), and the color value of CMYK is determined to be C≡M≡Y, K=0 (S15), halftone for K plane is applied to CMY plane (S16).

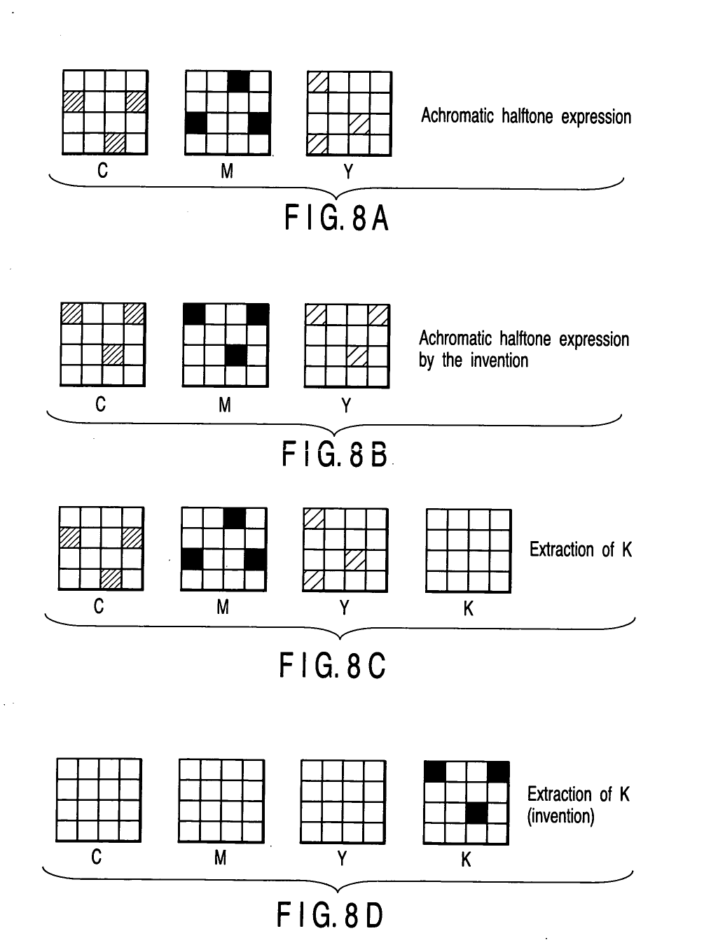

Herein; halftone for K plane is a conversion table for use in next binary conversion exclusively for the K signal. In this binary conversion process, it is expressed by replacing with plural matrix dots as shown in FIG. 8A or the like depending on the image signal having a concentration value, and it is specified by the image signal to print in which dot distribution.

In step S15, if the image signal is determined to be an achromatic color, for example, the values of Y, M and C are nearly equal. Further, by binary conversion by using similar halftone (conversion table) (S17), for example, nearly identical binary signals can be outputted as for YMC. That is, by using the halftone for K plane also for binary conversion of Y signal, M signal and C signal, the values of Y, M and C may be almost equalized.

The binary conversion process is followed by predetermined ROP process about these binary signals (S18). Herein, predetermined ROP is an operation of overwriting Texture only on Destination, for example, when ROP3=240. This operation is mainly used in depiction of a pattern or a character such as identical mask processing in all colors. Texture is generated by binary conversion by using halftone data (dither method, error diffusion method, etc.) on the color value of a pattern (pattern applied to an object). If there is a mask pattern specified by the user, logic operation of OR is effected on the original pattern and mask pattern at the time of texture generation. By this operation, on the pixels on which bits in the mask pattern specified by the user are set up are written into Destination, but pixels on which no bit is set up are directly outputted from Destination, and an equalized image is obtained, so that raster processing is realized.

After ROP process, when all these processes are completed in all objects (S19), component K is extracted by K generation logic (S20).

If K plane processing about the invention is not effected, as shown in FIG. 8B, although achromatic halftone (C≡M≡Y) has been depicted but, as shown in FIG. 8C, since standing positions of bits are not overlapped in the binary data, component K cannot be extracted. Accordingly, achromatic halftone is expressed by a composite color of components CMY, so that expensive color ink is waste and color blurring occurs.

By K plane processing in step S16, on the other hand, as shown in FIG. 8B, by applying the same K halftone pattern to the components CMY, the pattern (screen information) may be same as in each plane of CMY. Therefore, as a result of K generation process, as shown in FIG. 8D, the image can be formed by component K alone without using component C, component M and component Y. Hence, in the object accompanied by ROP, the color of achromatic halftone can be outputted by the print control signal of only component K.

In step S13, when the target object is an image, usual process is done, and K monochromatic process of the invention is not carried out even in the case of composite black of CMYK. Similarly, in step S14, in the case of not predetermined ROP, without K plane processing, ordinary process is executed.

Thus, according to the K plane processing of the invention, by changing over the halftone (conversion table) for use in binary processing so that the result of ROP is achromatic, K can be extracted without changing K plane to CMY plane by OR before ROP, and the object can be outputted by component K only.

Herein, achromatic determination is determined by using the color value after cover conversion, but it is also possible to determine achromatic determination by using the color value (input color value) before color conversion.

### Second Embodiment

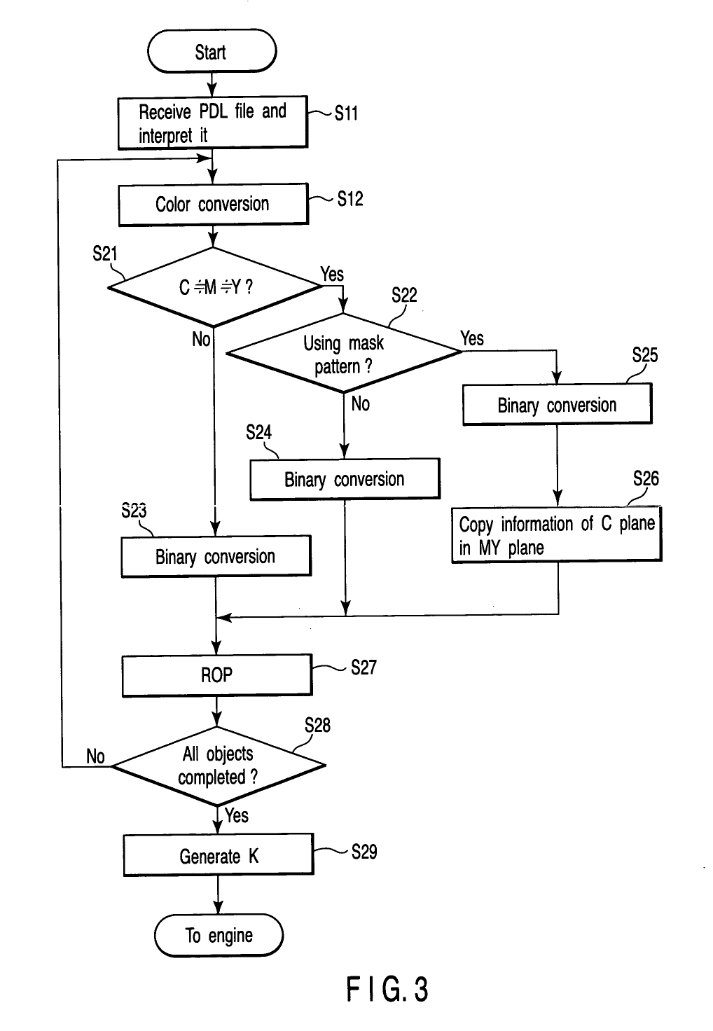

In a second embodiment of the present invention, in a printer controller unit, by identifying the CMY plane, an achromatic signal is outputted by a print control signal expressed by K signal alone without using YMC signals, and an image is formed by only K toner in a printer engine. The processing flowchart of the second embodiment is shown in FIG. 3, but the basic configuration is same as in the first embodiment, the explanation thereof is omitted, and only different points are described below.

That is, in 8-bit data before binary conversion, it is determined whether C≡M≡Y or not (S21). Next, an object is determined to be whether or not a predetermined ROP type using the same mask pattern in each plane (S22). At this time, the same mask pattern is stored in the K plane. In step S21 and step S22, if Yes, C signal is binary coded (S25), and binary C plane information is copied in MY plane (S26). As a result, at the time of ROP (S27), screen information belongs to the C plane, but when completed in all objects (S28), the print control signal can be outputted by only component K, as shown in FIG. 8D, same as in the first embodiment, by component K extraction process, and the image can be formed of only K toner in the printer engine.

Herein, not only the information of C plane is copied in the information of M plane or Y plane, but also the information of M plane can be copied in the information of C plane or Y plane, or the information of Y plane can be copied in the information of C plane or M plane, similarly.

### Third Embodiment

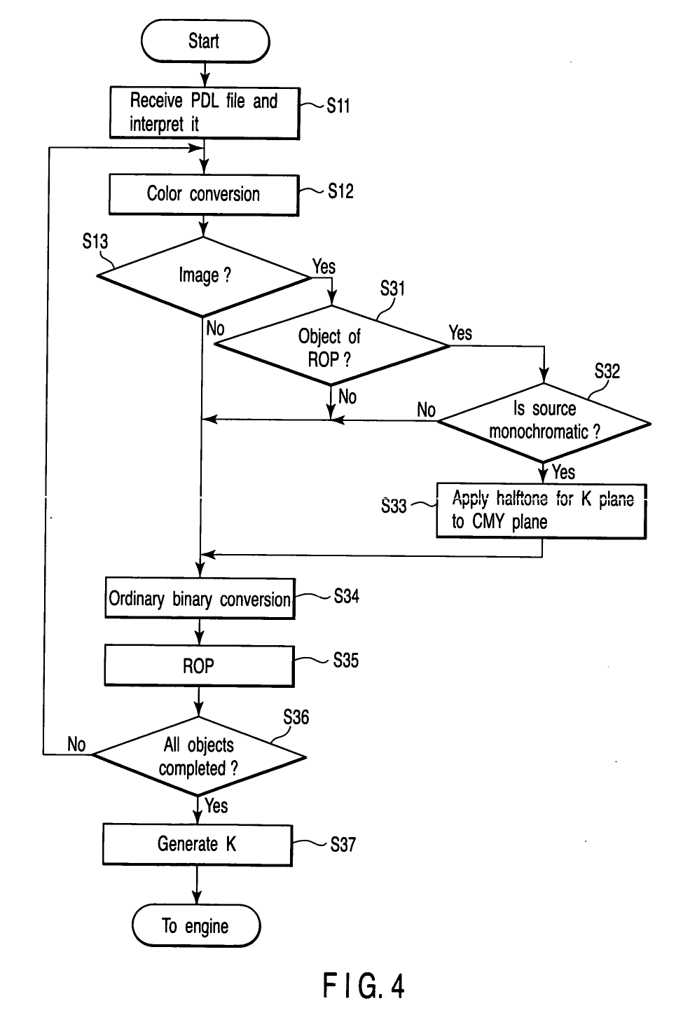

In a third embodiment of the present invention, in a printer controller unit by K plane processing depending on the type of image, an achromatic signal is outputted by a print control signal expressed by K signal alone without using YMC signals, and an image is formed by only K toner in a printer engine. The processing flowchart of the third embodiment is shown in FIG. 4, but the basic configuration is same as in the first embodiment, the explanation thereof is omitted, and only different points are described below.

The processing flowchart of the third embodiment is shown in FIG. 4, but the basic configuration is same as in FIG. 2, except that, in step S13, it is determined whether an image object or not, and if Yes, it is determined whether or not the image signal is a ROP intended object (S31). In the case of the image object and ROP intended object, it is determined whether or not the source (image object in this case) is an achromatic object in the ROP, on the basis of the color of image pixel, whether C=M=Y or R=G=B, etc. (excluding 100% white or black) (S32).

In steps S13, S31, S32, if Yes in all, all the halftone patterns (by dither, error diffusion method) on CMY plane are applied to halftone patterns for K plane (S33).

Thereafter, the object is binary coded (S34), and further ROP process is executed (S35). Thus, by changing over the halftone, component K can be extracted from the data after ROP, and the achromatic image object can be outputted by only component K without having to express by CMY composite color.

By thus processing, in the objects to be overlaid, the color of achromatic halftone can be reproduced sufficiently by the component K. In the case of the achromatic object not accompanied by ordinary ROP (overwriting), only by changing over the halftone pattern, it is possible to reproduce by single K color only without having to express by CMY composite color.

In the case of the object not including ROP process, of course, the output is possible in single K color only by changing over the halftone pattern in the case of the achromatic object.

### Fourth Embodiment

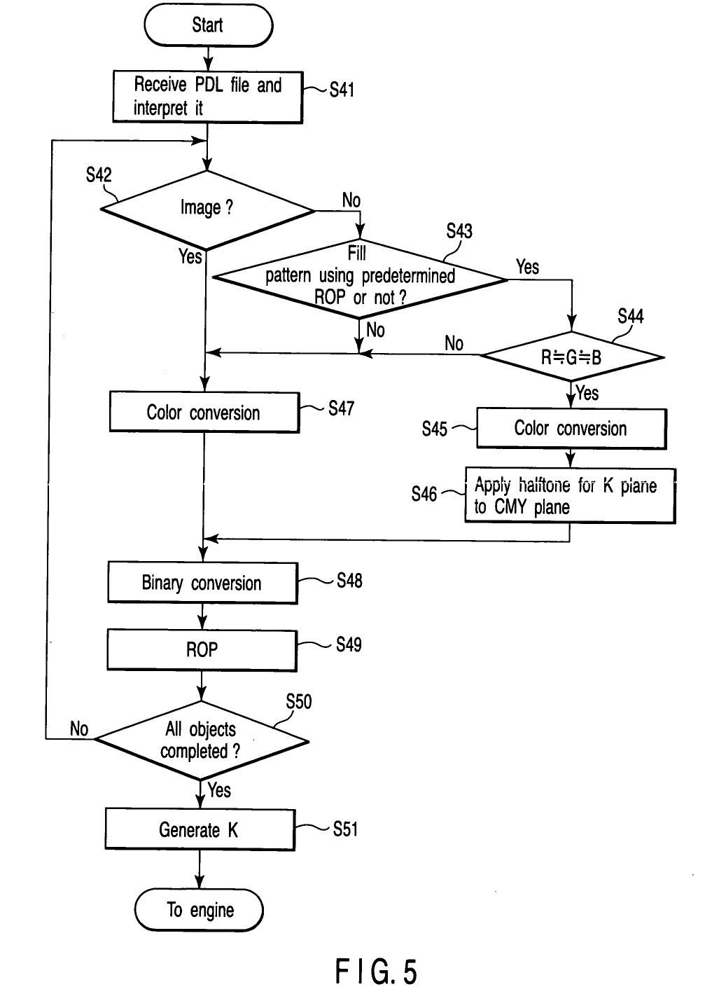

In a fourth embodiment of the present invention, similarly, in a printer controller unit, by K plane processing, an achromatic signal is outputted by a print control signal expressed by K signal alone without using YMC signals, and an image is formed by only K toner in a printer engine, but by determining the achromatic color before color conversion process, it is possible to determine correctly without having effects of conversion process. The processing flowchart of the fourth embodiment is shown in FIG. 5, but the basic configuration is same as in the first embodiment, the explanation thereof is omitted, and only different points are described below.

That is, in the first to third embodiments, in an achromatic determining unit for the color value in 8 bits, it has been determined by referring to the color value of color conversion after color conversion (C≡M≡Y or CMY=0, K=x). But in the fourth embodiment, before color conversion in step S45, the achromatic color is determined in step S44. By referring to the color value before color conversion, if it is achromatic at the input side, it can be reproduced. The process in other steps S41 to S51 is nearly same as in the process described above, and the explanation thereof is omitted.

### Fifth Embodiment

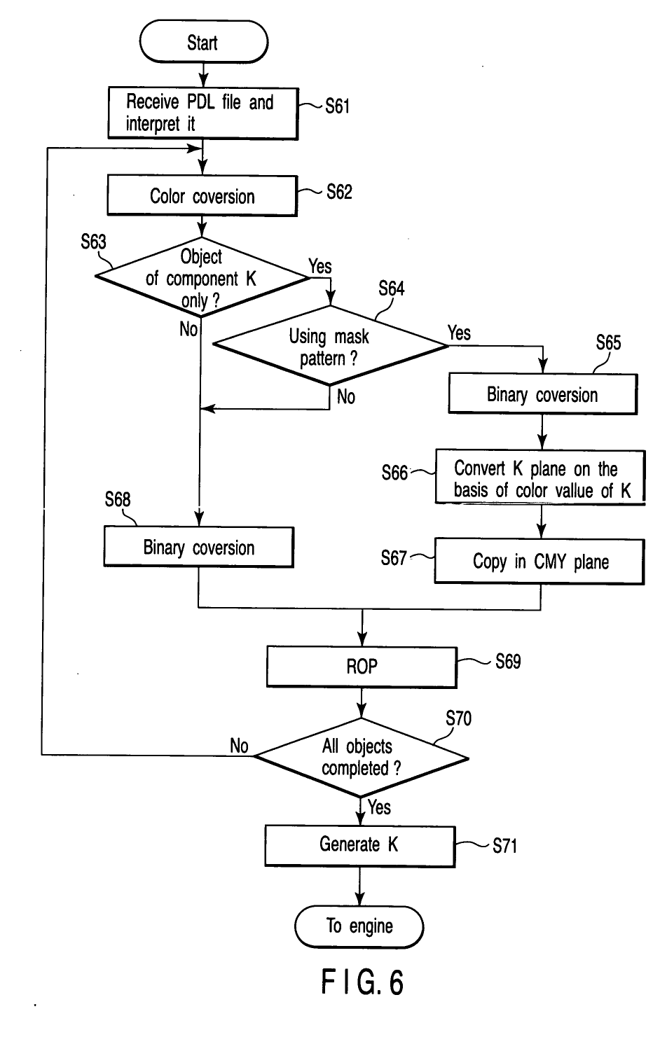

In a fifth embodiment of the present invention, it is characterized by the process of determining whether or not the target object is composed of 8 bits and component K alone. The processing flowchart of the fifth embodiment is shown in FIG. 6. In the processing flowchart in the fifth embodiment, the basic configuration is same as in the first embodiment, the explanation thereof is omitted, and only different points are described below.

That is, in step S63, it is determined whether or not the target object is composed of 8 bits and component K alone. In the case of the object expressed by component K alone, it is determined whether or not this object is a predetermined ROP type using the same mask pattern in each plane (S64). If affirmative (K plane is a mask pattern), after binary processing (S65), the mask pattern of K plane is converted into a bit pattern obtained from the value of component K of 8 bits (S66).

At this time, a converted proper bit pattern is copied in CMY (S67). To copy the obtained bit pattern in CMY is based on the assumption that the object accompanied by ROP process comes further on the object being processed. By this processing, even in the case of using ordinary ROP, component K can be reproduced. The process from step S61 to step S71 is similar to the process in the flowchart in FIG. 2, and the explanation thereof is omitted.

### Other Embodiments

In the foregoing embodiments, the function for executing the objects of the invention has been preliminarily recorded in the apparatus, but not limited to these examples, similar functions may be downloaded into the apparatus from the network, or a recording medium storing such functions may be installed in the apparatus. Any recording medium may be used such as a CD-ROM, as far as the program can be stored and the recording medium can be read by the apparatus. Such functions obtained by installing preliminarily or downloading may be designed to express the functions by cooperation with the OS (operating system) or the like in the apparatus.

As described herein, according to the printer controller unit of the invention and the image forming apparatus using the same, at the time of ROP process after screening, the achromatic halftone object is not outputted in composite color of CMY or CMYK, but is outputted in only component K, thereby image can be formed. Thus, at the time of forming an image, the object is not distorted by plate deviation, and further the image can be formed by inexpensive K toner alone without using expensive color toner.

What is claimed is:

1. A printer controller comprising:
an interpreting unit which receives a plurality of color image information from outside and interprets the information;
a binary converting unit which converts said plurality of color image information into binary information in a pattern depending on the magnitude of the information, and further outputs each of said plurality of color image information in information of the same pattern when the interpreting unit interprets that the color image information is achromatic and that ROP (raster operation) process is needed;
an ROP processing unit which applies ROP process to the binary information from the binary converting unit; and
a generating unit which generates and outputs information of a pattern for forming an image by black pixel when said plurality of color image information are the same pattern information on the basis of said plurality of binary information outputted from the ROP processing unit.

2. The printer controller according to claim 1, wherein the binary converting unit performs binary conversion by applying a conversion table of one color image information in conversion process of another color image information as well, with respect to a conversion table intrinsic to said plurality of color image information for use in binary conversion, and whereby outputs all said plurality of color image information in information of the same pattern.

3. The printer controller according to claim 1, wherein, when said plurality of color image information are YMCK, the binary converting unit performs binary conversion by applying a conversion table of component K in conversion process of component Y, component Y and component C as well, with respect to a conversion table intrinsic to said plurality of color image information for use in binary conversion, and whereby outputs component Y, component M, component C, and component K in information of the same pattern.

4. The printer controller according to claim 1, wherein the binary converting unit outputs binary information corresponding to one color image information of said plurality of color image information also as binary information of another color image information.

5. The printer controller according to claim 1, wherein said plurality of color image information are obtained from PDL (page description language) to be supplied from an external printer driver.

6. The printer controller according to claim 1, wherein said plurality of color image information are C (cyan), M (magenta), Y (yellow), and K (black).

7. The printer controller according to claim 1, wherein said plurality of color image information are R (red), G (green), and B (blue).

8. The printer controller according to claim 1, wherein the binary converting unit outputs each of said plurality of color image information in information of the same pattern only when it is interpreted that said plurality of color image information are of a predetermined image type, showing an achromatic color, and that the ROP (raster operation) process is needed.

9. The printer controller according to claim 1, wherein the binary converting unit outputs each of said plurality of color image information in information of the same pattern only when it is interpreted that said plurality of color image information are image pictures, showing an achromatic color, and that the ROP (raster operation) process is needed.

10. The printer controller according to claim 1, wherein the binary converting unit outputs each of said plurality of color image information in information of the same pattern only when it is interpreted that said plurality of color image information are of a predetermined mask pattern, showing an achromatic color, and that the ROP (raster operation) process is needed.

11. The printer controller according to claim 1, wherein the binary converting unit determines whether or not said plurality of color image information show an achromatic color after color conversion of the color image information.

12. The printer controller according to claim 1, wherein the binary converting unit converts the color of said plurality of color image information after determining whether achromatic or not.

13. An image forming apparatus comprising:
an interpreting unit which receives a plurality of color image information from outside and interprets the information;
a binary converting unit which converts said plurality of color image information into binary information in a pattern depending on the magnitude of the information, and further outputs each of said plurality of color image information in information of the same pattern when the interpreting unit interprets that the color image information is achromatic and that ROP (raster operation) process is needed;
an ROP processing unit which applies ROP process to the binary information from the binary converting unit;
a generating unit which generates and outputs information of a pattern for forming an image by black pixel when said plurality of color image information are information of the same pattern on the basis of said plurality of binary information outputted from the ROP processing unit; and
an image forming unit which forms an image on a recording medium on the basis of binary information showing a pattern from the generating unit.

14. The image forming apparatus according to claim 13, wherein the binary converting unit performs binary conversion by applying a conversion table of one color image information in conversion process of another color image information as well, with respect to a conversion table intrinsic to said plurality of color image information for use in binary conversion, and whereby outputs all said plurality of color image information in information of the same pattern.

15. The image forming apparatus according to claim 13, wherein, when said plurality of color image information are YMCK, the binary converting unit performs binary conversion by applying a conversion table of component K in conversion process of component Y, component Y and component C as well, with respect to a conversion table intrinsic to said plurality of color image information for use in binary conversion, and whereby outputs component Y, component M, component C, and component K in information of the same pattern.

16. The image forming apparatus according to claim 13, wherein the binary converting unit outputs binary information corresponding to one color image information of said plurality of color image information also as binary information of another color image information.

17. An image forming program which is read and executed by a computer to realize the following functions comprising:
receiving a plurality of color image information from outside and interpreting the information;
converting said plurality of color image information into binary information in a pattern depending on the magnitude of the information, and outputting each of said plurality of color image information in information of the same pattern when it is interpreted that the color image information is achromatic and that ROP (raster operation) process is needed;
applying ROP process to the binary information; and
generating and outputting information of a pattern for forming an image by black pixel when said plurality of color image information are information of the same pattern on the basis of said plurality of binary information outputted.

18. The image forming program according to claim 17, wherein the binary converting step outputs all said plurality of color image information in information of the same pattern by performing binary conversion by applying a conversion table of one color image information in conversion process of another color image information as well, with respect to a conversion table intrinsic to said plurality of color image information for used in binary conversion.

19. The image forming program according to claim 17, wherein, when said plurality of color image information are YMCK, the binary converting step outputs component Y, component M, component C, and component K in information of the same pattern by performing binary conversion by applying a conversion table of component K in conversion process of component Y, component Y and component C as well, with respect to a conversion table intrinsic to said plurality of color image information for use in binary conversion.

20. The image forming program according to claim 17, wherein the binary converting step outputs binary information corresponding to one color image information of said plurality of color image information also as binary information of another color image information.
